(19) United States
(12) Patent Application Publication
(10) Pub. No.: US 2018/0060941 A1
(43) Pub. Date: Mar. 1, 2018

(54) SECTIONALIZED APPARATUS AND METHOD FOR BATTERY MANUFACTURING PROCESS

(71) Applicant: Phoenix Silicon International Corp., Hsinchu (TW)

(72) Inventors: Mike YANG, Hsinchu (TW); Wen-Cheng CHENG, Hsinchu (TW)

(21) Appl. No.: 15/251,456

(22) Filed: Aug. 30, 2016

(51) Int. Cl. G06Q 30/06; H01M 10/44

(52) U.S. Cl. CPC G06Q 30/0637; H01M 10/446

(57) ABSTRACT

A sectionalized method for a battery manufacturing process includes the steps of: receiving at least one zeroth client purchase order having a zeroth quantity of the battery assembly. If the zeroth quantity is no less than a zeroth predetermined number, or if an accumulated zeroth quantity is no less than the zeroth predetermined number, then a first proposal is generated to propose the client end to build a first production line to assemble cells into battery assemblies.

### BACKGROUND OF INVENTION

### 1. Field of the Invention

The invention relates to a sectionalized apparatus and a sectionalized method for a battery manufacturing process, and more particularly to the apparatus and the method that can divide a whole battery manufacturing process into several sections and propose orderly to construct at least one production line for each individual section.

### 2. Description of the Prior Art

Owing to the rising awareness of environment protection, more and more merchandises claimed to save the energy and reduce the carbon have been introduced to the market place, such as various electric apparatuses. Among these electric apparatuses, the electric vehicle is one of the most representative products.

The core of electric vehicle technology is the battery assembly that energizes the vehicle. Currently, the battery assembly comes mainly from two sources: production by oneself and outsourcing.

Nevertheless, some manufacturers of the electric vehicles would prefer to produce the battery assemblies by themselves so as not to worry about a steady supply from the outsourcing. However, to construct a complete production line for the battery assemblies is expensive, which is usually the reason for inhibiting the manufacturers of the electric vehicles to produce the battery assemblies by themselves. Hence, it is worthy to search for a compromise or a commercial model that can benefit both the manufacturers and the outsourcing.

### SUMMARY OF THE INVENTION

Accordingly, it is the primary object of the present invention to provide a sectionalized apparatus and a sectionalized method for a battery manufacturing process, that can divide a whole battery manufacturing process into several manufacturing sections, such that at least one battery manufacturer can build corresponding production lines according to an instant proposal. Thereby, the cost for building a complete production line of the battery assemblies can be successfully dispersed.

In the present invention, the sectionalized method for a battery manufacturing process, applied to a sectionalized apparatus for the battery manufacturing process, comprises the steps of:

at least one client end issuing at least one zeroth client purchase order, a threshold module of the sectionalized apparatus receiving the at least one zeroth client purchase order having a zeroth quantity, and a proposal-generating module of the sectionalized apparatus generating a first proposal to propose the client end to build a first production line for assembling cells into battery assemblies if the threshold module judges either the zeroth quantity or an accumulated zeroth quantity is no less than a zeroth predetermined number; and

determining if the client end accepts the first proposal or not, the proposal-generating module receiving a confirmation message from the client end that tells acceptance of the first proposal if the client end accepts the first proposal and the first production line has already been established, the client end issuing at least one first client purchase order, the threshold module receiving the at least one first client purchase order, the first client purchase order having a first quantity of at least one of secondary activated cells and cell assemblies, the proposal-generating module generating a second proposal provided to the client end if the threshold module judges either the first quantity or an accumulated first quantity is no less than a first predetermined number, and the second proposal proposing the client end to build a second production line of secondary activation.

It is another object of the present invention to provide a sectionalized apparatus for a battery manufacturing process that comprises:

a client database;

a threshold module, electrically coupled with the client database; and

a proposal-generating module, electrically coupled with the threshold module;

wherein at least one client end issues at least one client purchase order, the client database stores the at least one client purchase order, the client purchase order has a quantity, the threshold module determines whether or not the quantity is no less than a predetermined number, the proposal-generating module generates a proposal if positive, and the proposal-generating module receives a confirmation message from the client end that tells acceptance of the proposal by the client end.

All these objects are achieved by the sectionalized apparatus and method for a battery manufacturing process described below.

### BRIEF DESCRIPTION OF THE DRAWINGS

The present invention will now be specified with reference to its preferred embodiment illustrated in the drawings, in which:

FIG. 1 is a schematic view of a sectionalized apparatus for a battery manufacturing process in accordance with the present invention;

FIG. 2 is a part of a flowchart of a sectionalized method for a battery manufacturing process in accordance with the present invention;

FIG. 3 is a continued flowchart of FIG. 2; and

FIG. 4 is a continued flowchart of FIG. 3.

### DESCRIPTION OF THE PREFERRED EMBODIMENT

The invention disclosed herein is directed to a sectionalized apparatus and a sectionalized method for a battery manufacturing process. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

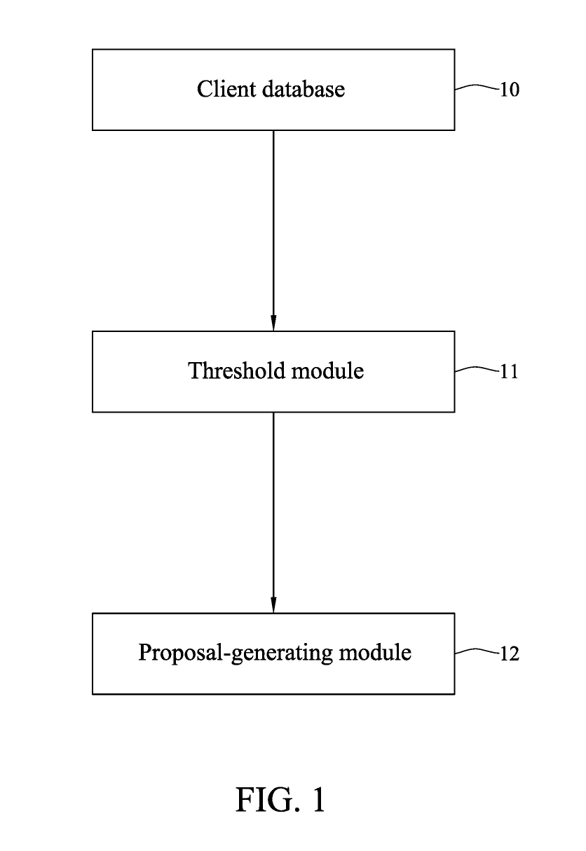

Referring now to FIG. 1, the sectionalized apparatus for a battery manufacturing process includes a client database 10, a threshold module 11 and a proposal-generating module 12.

The client database 10 is to store a client purchase order having a quantity.

The threshold module 11 electrically coupled with the client database 10 is to determine whether or not the quantity exceeds a predetermined number.

The proposal-generating module 12 is electrically coupled with the threshold module 11. If the aforesaid quantity exceeds the predetermined number, then the proposal-generating module 12 would generate a corresponding proposal. The proposal is stored into the client database 10. The proposal-generating module 12 is to receive a message from a client end confirming that the client accepts the proposal.

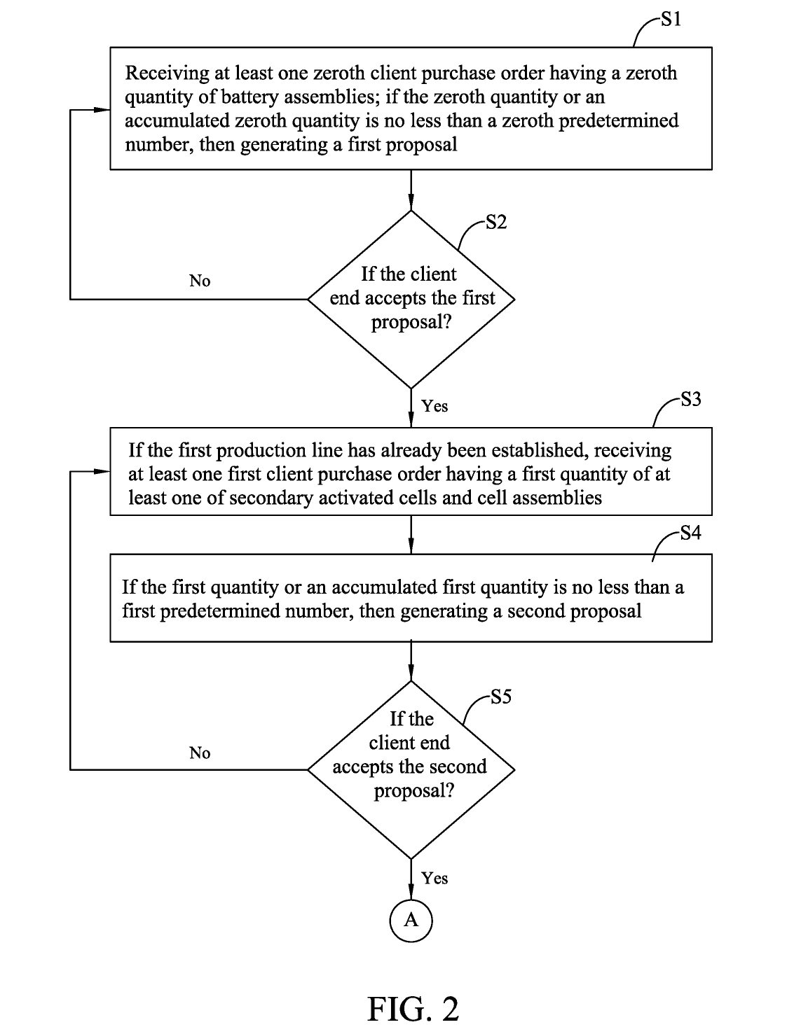

Referring now to FIG. 2 through FIG. 4, the sectionalized method for a battery manufacturing process includes the following steps.

Step S1: As shown in FIG. 1 and FIG. 2, after at least one client end issues at least one zeroth client purchase order, the at least one zeroth client purchase order is then received. The zeroth client purchase order is a purchase order of the battery assemblies having a zeroth quantity, and is stored into the client database 10. The threshold module 11 determines if the zeroth quantity, as a single quantity, is no less than (larger than or equal to) a zeroth predetermined number, or alternatively if an accumulated quantity summarized by a plurality of the zeroth quantities is no less than the zeroth predetermined number, then the proposal-generating module 12 generates a first proposal. The first proposal provided to the client end is to propose the client end to build the first production line for assembling cells into the corresponding battery assembly. Namely, in the present invention, the battery assembly is consisted of a plurality of cells, and the first proposal is stored in the client database 10.

Step S2: Determine if the client end accepts the first proposal or not. If the client end accepts the first proposal, then go to perform the following Step S3. In this step, the proposal-generating module 12 receives the confirmation message from the client end that tells the acceptance of the first proposal by the client. If the client end does not accept the first proposal, then go back to Step S1.

Step S3: If the first production line has already been established, then receive at least one first client purchase order. The first client purchase order is also stored into the client database 10. The first client purchase order is a purchase order of at least one of secondary activated cells and cell assemblies, where the purchase order has a first quantity. Namely, cells in the first purchase have been experienced a secondary activation process.

In the present invention, the secondary activation is the scenery as described below. After the cell experiences a pre-charge to have a second power and after a preset time, the decay of the second power in the cell is checked. If the second power of the cell is lower than a predetermined power value, then the cell is recharged so as to have a third power. In the present invention, the third power should be no less than the predetermined power value.

For example, if the second power is lower than 80˜97% of the predetermined power value, then the cell needs to be recharged so as to have the third power.

In the present invention, the preset time can be a few days, a few weeks or a few months, and the preset time is the time for transporting the cells to the client end.

Step S4: If the threshold module 11 determines that the first quantity is no less than a first predetermined number, or if the accumulated quantity of the first quantities is no less than the first predetermined number, then the proposal-generating module 12 would generate a second proposal provided to the client end for proposing the client end to establish a second production line of the secondary activation. In particular, the second proposal is stored in the client database 10.

Step S5: Determine whether or not the client end accepts the second proposal. If the client end accepts the second proposal, then go to the next step. In this step, the proposal-generating module 12 receives the confirmation message from the client end that tells the acceptance of the second proposal by the client. If the client end does not accept the second proposal, then go back to Step S3.

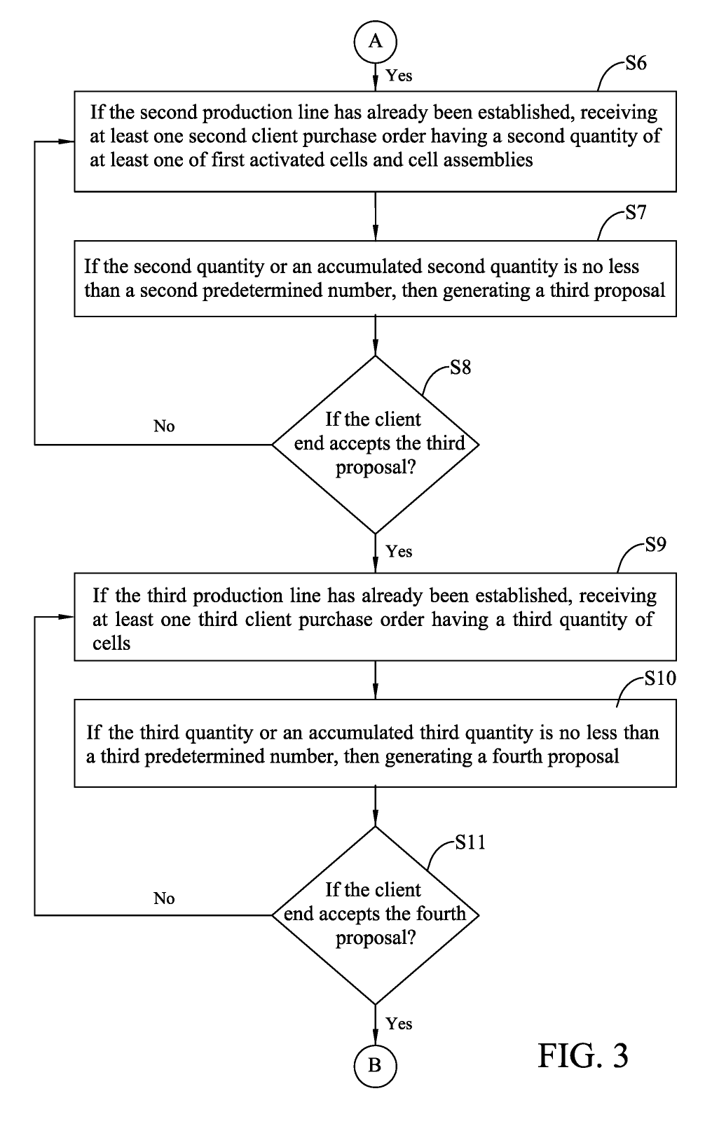

Step S6: As shown in FIG. 3, if the second production line has already been established, then receive at least one second client purchase order. The second client purchase order is stored into the client database 10. The second client purchase order is a purchase order of at least one of first activated cells and cell assemblies, where the purchase order has a second quantity. The second quantity is the cell quantity that the second production line requires. The cells within this second quantity have been experienced a fixation sealing process, a first activation process and a pre-charging process.

The pre-charging process is a charging process upon a cell without any power.

The first activation process is to have the cell to have a first power.

The fixation sealing process is to perform an air-tight sealing process upon the cell.

Step S7: If the second quantity is no less than a second predetermined number, or if the accumulated quantity of the second quantities is no less than the second predetermined number, then the threshold module 11 would base on the client database 10 to have the proposal-generating module 12 to generate a third proposal provided to the client end for proposing the client end to establish a third production line to perform a fixation sealing process, a first activation process and a pre-charging process. In particular, the third proposal is stored in the client database 10.

Step S8: Determine whether or not the client end accepts the third proposal. If the client end accepts the third proposal, then go to the next step. In this step, the proposal-generating module 12 receives the confirmation message from the client end that tells the acceptance of the third proposal by the client. If the client end does not accept the third proposal, then go back to Step S6.

Step S9: If the third production line has already been established, then receive at least one third client purchase order. The third client purchase order is a purchase order of cells having a third quantity. The third quantity is the cell quantity that the third production line requires. The cells within this third quantity have been experienced an electrolyte-infusing process and a sealing process.

Step S10: If the threshold module 11 determines that the third quantity is no less than a third predetermined number, or if the accumulated quantity of the third quantities is no less than the third predetermined number, then the proposal-generating module 12 would generate a fourth proposal provided to the client end for proposing the client end to establish a fourth production line to perform the electrolyte-infusing process and the cell-sealing process. In particular, the fourth proposal is stored in the client database 10.

Step S11: Determine whether or not the client end accepts the fourth proposal. If the client end accepts the fourth proposal, then go to the next step. In this step, the proposal-generating module 12 receives the confirmation message from the client end that tells the acceptance of the fourth proposal by the client. If the client end does not accept the fourth proposal, then go back to Step S9.

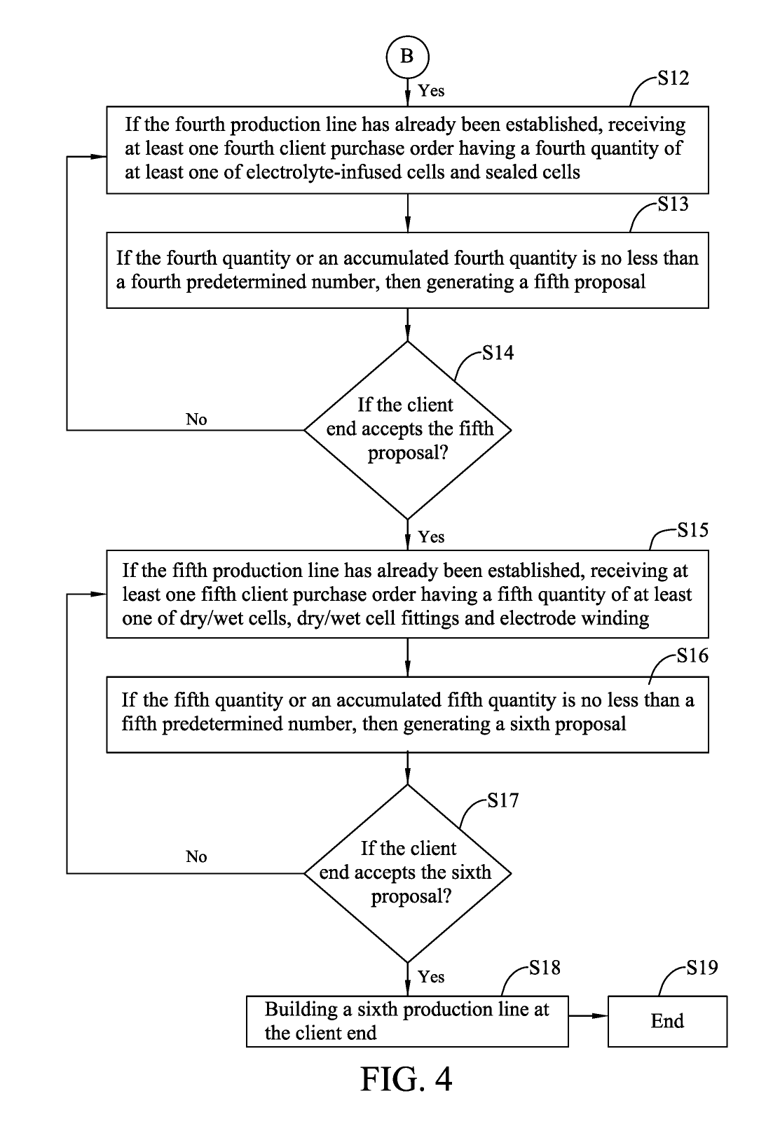

Step S12: As shown in FIG. 4, if the fourth production line has already been established, then receive at least one fourth client purchase order. The fourth client purchase order is stored into the client database 10. The fourth client purchase order is a purchase order of at least one of electrolyte-infused cells and sealed cells, where the purchase order has a fourth quantity. The cells within this fourth quantity are provided to the fourth production.

Step S13: If the threshold module 11 determines that the fourth quantity is no less than a fourth predetermined number, or if the accumulated quantity of the fourth quantities is no less than the fourth predetermined number, then the proposal-generating module 12 would generate a fifth proposal provided to the client end for proposing the client end to establish a fifth production line to perform a cell-assembling process and an electrode-winding process. In particular, the fifth proposal is stored in the client database 10.

Step S14: Determine whether or not the client end accepts the fifth proposal. If the client end accepts the fifth proposal, then go to the next step. In this step, the proposal-generating module 12 receives the confirmation message from the client end that tells the acceptance of the fifth proposal by the client. If the client end does not accept the fifth proposal, then go back to Step S12.

Step S15: If the fifth production line has already been established, then receive at least one fifth client purchase order. The fifth client purchase order is stored into the client database 10. The fifth client purchase order is a purchase order of at least one of dry/wet cells, dry/wet cell fittings and electrode winding, where the purchase order has a fifth quantity. The purchase order having this fifth quantity is provided to the fifth production.

Step S16: If the threshold module 11 determines that the fourth quantity is no less than a fifth predetermined number, or if the accumulated quantity of the fifth quantities is no less than the fifth predetermined number, then the proposal-generating module 12 would generate a sixth proposal provided to the client end for proposing the client end to establish a sixth production line to produce an isolating film, a tab and an electrode. In particular, the sixth proposal is stored in the client database 10. The tab can be either cut or uncut, and the electrode can be either coated or uncoated.

Step S17: Determine whether or not the client end accepts the sixth proposal. If the client end accepts the sixth proposal, then go to the next step. In this step, the proposal-generating module 12 receives the confirmation message from the client end that tells the acceptance of the sixth proposal by the client. If the client end does not accept the sixth proposal, then go back to Step S15.

Step S18: The client end builds the sixth production line, and then, as the sixth production line has been established, Step S19 (the end) is performed.

In summary, according to the present invention, the sectionalized apparatus and method for a battery manufacturing process are to divide the whole battery-assembly manufacturing process into several sectionalized processes. In each of the sectionalized processes, the single quantity and the accumulated quantity requested from the client end is judged to be larger than or equal to a predetermined number (the zeroth to fifth predetermined number) or not. If positive, then establishment of the corresponding production line for the respective sectionalized process (the first to sixth production line) is proposed to the client end. By these sectionalized production lines, the cost for producing the whole battery assembly can be dispersed, and any manufacturer of the electronic apparatus using the battery assembly can be transformed into a manufacturer of the battery assembly.

While the present invention has been particularly shown and described with reference to a preferred embodiment, it will be understood by those skilled in the art that various changes in form and detail may be without departing from the spirit and scope of the present invention.

What is claimed is:

1. A sectionalized method for a battery manufacturing process, applied to a sectionalized apparatus for the battery manufacturing process, the sectionalized method comprising the steps of:
at least one client end issuing at least one zeroth client purchase order, a threshold module of the sectionalized apparatus receiving the at least one zeroth client purchase order having a zeroth quantity, and a proposal-generating module of the sectionalized apparatus generating a first proposal to propose the client end to build a first production line for assembling cells into battery assemblies if the threshold module judges either the zeroth quantity or an accumulated zeroth quantity is no less than a zeroth predetermined number; and
determining if the client end accepts the first proposal or not, the proposal-generating module receiving a confirmation message from the client end that tells acceptance of the first proposal if the client end accepts the first proposal and the first production line has already been established, the client end issuing at least one first client purchase order, the threshold module receiving the at least one first client purchase order, the first client purchase order having a first quantity of at least one of secondary activated cells and cell assemblies, the proposal-generating module generating a second proposal provided to the client end if the threshold module judges either the first quantity or an accumulated first quantity is no less than a first predetermined number, and the second proposal proposing the client end to build a second production line of secondary activation.

2. The sectionalized method for a battery manufacturing process of claim 1, wherein, if the client end does not accept the first proposal, the sectionalized method goes back to the step of issuing the zeroth client purchase order; wherein the secondary activation is, after a cell experiences a pre-charge to have a second power and after a preset time, to check decay of the second power in the cell, the cell is recharged to have a third power if the second power of the cell is lower than a predetermined power value, and the third power is no less than the predetermined power value; wherein the preset time is one of a few days, a few weeks and a few months, and the preset time is the time for transporting the cell to the client end.

3. The sectionalized method for a battery manufacturing process of claim 1, further including a step of determining whether or not the client end accepts the second proposal; wherein, if the client end accepts the second proposal and the second production line has been established, the proposal-generating module receives a confirmation message from the client end that tells acceptance of the second proposal; the client end issuing at least one second client purchase order, the threshold module accepting the at least one second client purchase order, the second client purchase order having a second quantity of at least one of first activated cells and cell assemblies, the second quantity being the cell quantity that the second production line requires, the proposal-generating module generating a third proposal to propose the client end to build a third production line to perform a fixation sealing process, a first activation process and a pre-charging process if either the second quantity or an accumulated second quantity is no less than a second predetermined number.

4. The sectionalized method for a battery manufacturing process of claim 3, wherein, if the client end does not accept the second proposal, the sectionalized method goes back to the step of receiving the first client purchase order; wherein the pre-charging is a charging process upon a cell without any power; wherein the first activation process is to have the cell to have the first power; wherein the fixation sealing process is to perform an air-tight sealing process upon the cell.

5. The sectionalized method for a battery manufacturing process of claim 3, further including a step of determining whether or not the client end accepts the third proposal; wherein, if the client end accepts the third proposal and the third production line has been established, the proposal-generating module receives a confirmation message from the client end that tells acceptance of the third proposal; the client end issuing at least one third client purchase order, the threshold module accepting the at least one third client purchase order, the third client purchase order having a third quantity that the third production line requires, the proposal-generating module generating a fourth proposal to propose the client end to build a fourth production line to perform an electrolyte-infusing and a cell-sealing process if either the third quantity or an accumulated third quantity is no less than a third predetermined number.

6. The sectionalized method for a battery manufacturing process of claim 5, wherein, if the client end does not accept the third proposal, the sectionalized method goes back to the step of receiving the second client purchase order.

7. The sectionalized method for a battery manufacturing process of claim 5, further including a step of determining whether or not the client end accepts the fourth proposal; wherein, if the client end accepts the fourth proposal and the fourth production line has been established, the proposal-generating module receives a confirmation message from the client end that tells acceptance of the fourth proposal; the client end issuing at least one fourth client purchase order, the threshold module accepting the at least one fourth client purchase order, the fourth client purchase order having a fourth quantity of at least one of electrolyte-infused cells and sealed cells, the proposal-generating module generating a fifth proposal to propose the client end to build a fifth production line to perform a cell-assembling process and an electrode-winding process if either the fourth quantity or an accumulated fourth quantity is no less than a fourth predetermined number.

8. The sectionalized method for a battery manufacturing process of claim 7, wherein, if the client end does not accept the fourth proposal, the sectionalized method goes back to the step of receiving the third client purchase order.

9. The sectionalized method for a battery manufacturing process of claim 7, further including a step of determining whether or not the client end accepts the fifth proposal; wherein, if the client end accepts the fifth proposal and the fifth production line has been established, the proposal-generating module receives a confirmation message from the client end that tells acceptance of the fifth proposal; the client end issuing at least one fifth client purchase order, the threshold module accepting the at least one fifth client purchase order, the fifth client purchase order having a fifth quantity of at least one of dry/wet cells, dry/wet cell fittings and electrode winding, the proposal-generating module generating a sixth proposal to propose the client end to build a sixth production line to produce an isolating film, a tab and an electrode if either the fifth quantity or an accumulated fifth quantity is no less than a fifth predetermined number.

10. The sectionalized method for a battery manufacturing process of claim 9, wherein, if the client end does not accept the fifth proposal, the sectionalized method goes back to the step of receiving the fourth client purchase order.

11. The sectionalized method for a battery manufacturing process of claim 9, further including a step of determining whether or not the client end accepts the sixth proposal; wherein, if the client end accepts the sixth proposal, the client end builds the sixth production line, and the proposal-generating module receives a confirmation message from the client end that tells acceptance of the sixth proposal.

12. The sectionalized method for a battery manufacturing process of claim 11, wherein, if the client end does not receive the sixth proposal, the sectionalized method goes back to the step of receiving the fifth client purchase order.

13. A sectionalized apparatus for a battery manufacturing process, comprising:
a client database;
a threshold module, electrically coupled with the client database; and
a proposal-generating module, electrically coupled with the threshold module;
wherein at least one client end issues at least one client purchase order, the client database stores the at least one client purchase order, the client purchase order has a quantity, the threshold module determines whether or not the quantity is no less than a predetermined number, the proposal-generating module generates a proposal if positive, and the proposal-generating module receives a confirmation message from the client end that tells acceptance of the proposal by the client end.
